(19) United States
(12) Patent Application Publication
(10) Pub. No.: US 2025/0219524 A1
(43) Pub. Date: Jul. 3, 2025

(54) SWITCHED-CAPACITOR CONVERTER TOPOLOGY WITH REDUCED SWITCH VOLT-AMP METRIC

(71) Applicant: THE REGENTS OF THE UNIVERSITY OF CALIFORNIA, Oakland, CA (US)

(72) Inventor: Sean David Alling, Davis, CA (US)

(73) Assignee: THE REGENTS OF THE UNIVERSITY OF CALIFORNIA, Oakland, CA (US)

(21) Appl. No.: 19/003,822

(22) Filed: Dec. 27, 2024

Related U.S. Application Data
(60) Provisional application No. 63/615,404, filed on Dec. 28, 2023.

(51) Int. Cl. H02M 1/00; H02M 3/07

(52) U.S. Cl. CPC H02M 1/0054; H02M 3/07

(57) ABSTRACT

An alternative topology implementation for Fibonacci switched-capacitor converters is described that maintains maximum conversion ratio given the same set of capacitors, while achieving a significant reduction in the Volt-Amp metric. Compared to a conventional Fibonacci switched capacitor converter with the same parts, those benefits can be achieved by changing one switch connection per capacitor in a conventional Fibonacci converter.

### CROSS-REFERENCE TO RELATED APPLICATIONS

This application claims priority to, and the benefit of, U.S. provisional patent application Ser. No. 63/615,404 filed on Dec. 28, 2023, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to switched-capacitor converters, and more particularly to an alternative topology for Fibonacci switched-capacitor converters that maintains maximum conversion ratio given the same set of capacitors, while significantly reducing the Volt-Amp metric.

### 2. Background Discussion

Switched Capacitor (SC) converters, such as 48 Volt to point-of-load DC-DC converters, have found extensive use in applications requiring minimal Electromagnetic Interference (EMI), high power density, and full integration. Switched capacitor converters are able to achieve fixed output voltage as a ratio of input voltage, and have a broad range of applications.

Fibonacci converters are one subclass of switched-capacitor converters able to realize maximum conversion ratios for a given set of capacitors. Although Fibonacci converters have advantages, they suffer a significant drawback with their increased Volt-Amp switch stress and high losses.

Accordingly, a need exists for enhanced Fibonacci converters that are not subject to the high switch stress and loss issues. The present disclosure fulfills that need and provides additional benefits over existing systems.

### BRIEF SUMMARY

This disclosure describes a switched-capacitor converter that exhibits reduced losses, increased efficiency, and less switch stress compared to a conventional Fibonacci converter. More particularly, compared to a conventional Fibonacci switched capacitor converter with the same parts, those benefits can be achieved by changing one switch connection per capacitor in a conventional Fibonacci converter, and thus retaining the same parts.

In addition, the switched-capacitor converter described in this disclosure can achieve the same conversion ratio as a Fibonacci converter in both step-up (output voltage is greater than input voltage) and step-down (output voltage lower than input voltage) configurations. Beneficially, the switched-capacitor converter of this disclosure can achieve up to a 38% reduction in total switch losses and an increase in efficiency compared to a conventional switched capacitor Fibonacci converter, and with less switch stress.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic diagram of a conventional switched capacitor unit cell.

FIG. 2A through FIG. 2C is a schematic and equivalent circuit diagrams showing a converter formed from three conventional switched-capacitor unit cells configured as a conventional 5:1 step-down Fibonacci converter.

FIG. 3A through FIG. 3C is a schematic and equivalent circuit diagrams showing a converter formed from three conventional switched-capacitor unit cells configured as a conventional 1:5 step-up Fibonacci converter.

FIG. 4 is a schematic diagram of a switched-capacitor step-down converter according to an embodiment of the present disclosure.

FIG. 5 is a schematic diagram of a switched-capacitor step-up converter according to an embodiment of the present disclosure.

FIG. 6 is a graph comparing Volt-Amp Metrics for a conventional Fibonacci converter (Blue) and a converter according to an embodiment of this disclosure (Red).

FIG. 7 is a schematic diagram of a switched-capacitor unit cell according to an embodiment of the present disclosure.

FIG. 8 is a timing diagram for operation of the switched-capacitor unit cell of FIG. 7 according to an embodiment of the present disclosure.

FIG. 9A and FIG. 9B are phase diagrams for operation of the switched-capacitor 5:1 step down unit cells of FIG. 4, shown according to an embodiment of the present disclosure.

### DETAILED DESCRIPTION

### 1. Switched Capacitor (SC) Fibonacci Converters

Fibonacci Switched Capacitor (SC) converters are electronic converter devices using a unique combination of capacitors and switches to convert voltage levels. Compared to many other SC converters, the Fibonacci SC converters use the fewest number of flying capacitors to perform conversion. Following are examples of known Fibonacci switched-capacitor converters.

### 1.1. Unit Cell of SC Converter

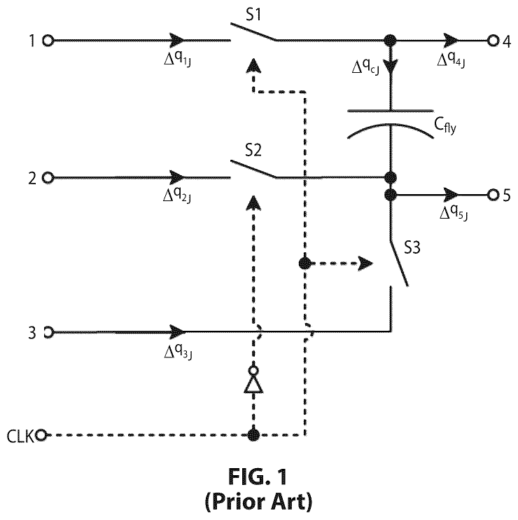

FIG. 1 illustrates a switched-capacitor converter unit cell having one capacitor and three switches. Three connections (1, 2, 3) are seen coupled through switches (S1-S3) to a flying capacitor C_{fly}, while two other connections (4, 5) are seen coupled directly to C_{fly}. A clock (CLK) controls two switches, and its inverted signal controls a third switch. Switches S1 and S3 are configured to be simultaneously on while S2 is off, or when S1 and S3 are off, then S2 will be on.

From this unit cell, switched capacitor Fibonacci converters can be composed in either a step-up configuration where the output voltage is higher than the input voltage, or in a step-down configuration where the output voltage is less than the input voltage.

More specifically connection 1 couples through a first switch S1 to a first side of the flying capacitor C_{fly}. A connection 2 connects through a second switch S2 to a second side of the flying capacitor C_{fly}. Connection 3 couples through a third switch S3 to the second side of the flying capacitor C_{fly}. The second and third switches are controlled from different phases of the clock signal.

### 1.2. Down Converting Fibonacci Converters

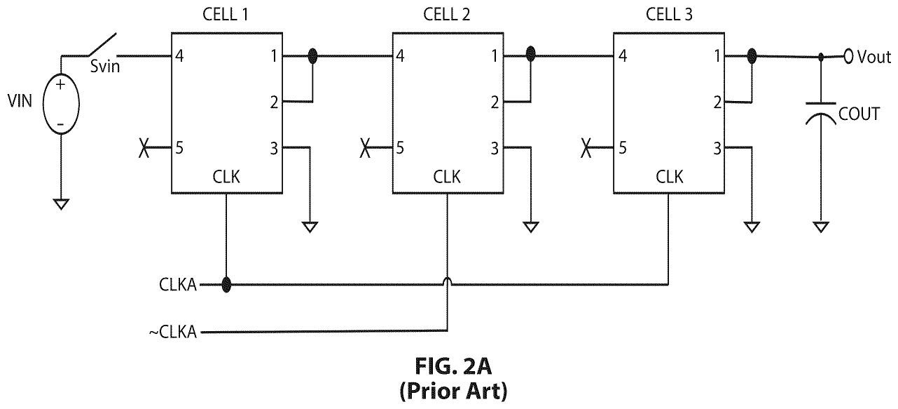

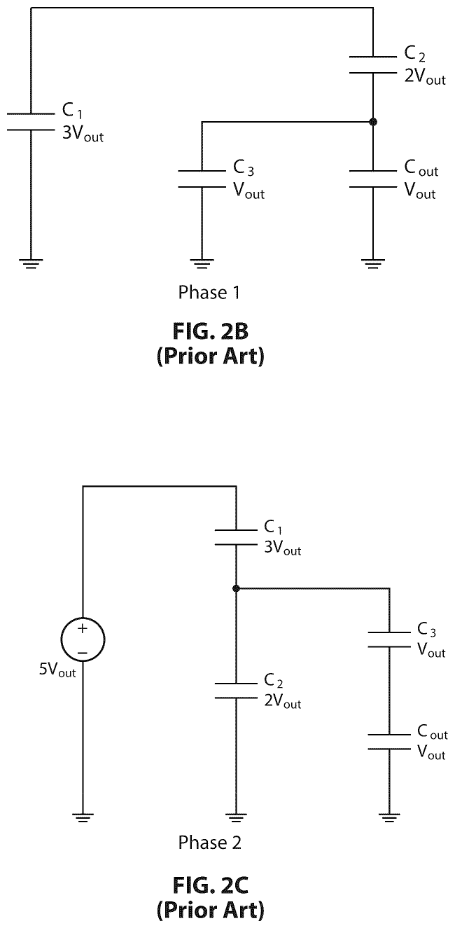

FIG. 2A through FIG. 2C depict a down converting Fibonacci Converter.

In FIG. 2A a Fibonacci converter is shown with multiple unit cells, each of which is as depicted in FIG. 1. The unit cells are cascaded to a desired number of unit cells to create higher conversion ratios, such as with three cells (e.g., Cell 1, Cell 2, and Cell 3) to configure this as a 5:1 step-down Fibonacci converter, thus having performed conversion in its three stages of to obtain a 5:1 conversion.

It will be noted that this example provides voltage-in (V_{IN}) being switched through switch S_{VIN}, which has the same clock as switch S2 in this first cell, to connection 4 of this first unit cell whose output of ganged connections 1 and 2 are coupled to the next cell in the series. Connection 3 of each cell is coupled to ground, and connection 5 of each cell 5 is left open. Connections 1 and 2 from the last unit cell are coupled to a capacitor C_{OUT} and having Voltage Vₒᵤₜ. CLKA is shown for controlling the first and third unit cells, while its inverse ˜CLKA is connected to the intermediate cell, thus showing that each cell uses an opposing phase clock from its preceding cell.

The three-stage step-down converter in FIG. 2A operates in two phases. In phase 1 switch S_{VIN} is open, and in Cell 1 and Cell 3, switches S2 is open while switches S1 and S3 are closed. In Cell 2 switch S2 is closed and switches S1 and S3 are open. In phase 2 switch S_{VIN} is closed, and in Cell 1 and Cell 3, switches S1 and S3 are open while switch S2 is closed. In Cell 2 switch S2 is open and switches S1 and S3 are closed.

Describing FIG. 2A from a connection standpoint, V_{IN} connects through an electronically controlled switch S_{VIN}, to connection 4 of CELL 1. In all three cells, connection 3 is coupled to ground, and connection 5 is left open, or coupled to connection 3. In CELL 1 connections 1 and 2 are coupled together and coupled to connection 4 of CELL 2. In CELL 2 connections 1 and 2 are coupled together and coupled to connection 4 of CELL 3. In CELL 3 connections 1 and 2 are coupled together to capacitor C_{OUT} with output Vₒᵤₜ.

CELL 1 and CELL 3 switches are controlled by clock signal CLKA, while CELL 2 switches are controlled by an inverted phase ˜CLKA. It should be noted that additional cells may be added between CELL 2 and CELL3, following the same pattern. The last SC unit cell shall merge its connection 1 and connection 2 to a capacitor C_{OUT}. For all SC unit cells in a conventional Fibonacci switched capacitor converter, connection 5 for all SC unit cells is left disconnected or coupled to connection 3.

FIG. 2B and FIG. 2C depicts equivalent capacitance diagrams of these two phases. It will be noted that the figure does not represent the switches, but instead depict how the flying capacitors work, where C1 is the flying capacitor from unit cell 1, C2 is the flying capacitor from unit cell 2, and C3 is the flying capacitor from unit cell 3.

It will be seen that the converter controls three switches in each unit cell. The input voltage of the first unit cell is from V_{IN}, through switch S_{VIN}, and each subsequent cell receives an input voltage from the previous cell, and the last cell in the series generates the converter output.

In phase 1 the input voltage is not connected, and the switches couple capacitor C3 in parallel with capacitor C_{OUT}, and also couples the series combination of capacitors C1 and C2 in parallel with the parallel combination of C3 and C_{OUT}.

In phase 2 each unit cell receives its input voltage which is connected by the switches to put the input voltage in a parallel combination with the series combination of capacitor C1 and capacitor C2, with the series combination of capacitors C3 and Cₒᵤₜ coupled in parallel with capacitor C2.

The following describes the steps in proving that the output voltage Vₒᵤₜ, is equal to the voltage across Cₒᵤₜ and thus follows the Fibonacci sequence.

(1) Assume Vₒᵤₜ for now is equal to 1 V.

(2) Assume the switched capacitor converter is operating in steady state, meaning a capacitor operates in the manner of a voltage source.

(3) When the circuit in FIG. 2A is in phase 1, as seen in FIG. 2B Cₒᵤₜ is parallel to C3. As the converter is in steady state, the voltage across C3 must equal the voltage across Cₒᵤₜ.

(4) Voltage across a capacitor must be equal across phases, as voltage across a capacitor cannot change instantaneously. Switching to phase 2 in FIG. 2C, Cₒᵤₜ and C3 are in series, which are in parallel with C2. Voltage across C3 was found to be equal to Vₒᵤₜ, and since the voltage across Cₒᵤₜ was assumed to be equal to Vₒᵤₜ, the total voltage across the series of C3 and Cₒᵤₜ is equal to 2Vₒᵤₜ. As C2 is in parallel with C3 and Cₒᵤₜ, the voltage across C2 must be equal to 2Vₒᵤₜ.

(5) Switching back to phase 1, in FIG. 2B the voltage of C1 can now be found. C1 is in parallel to either the series connection of C2 and C3 or the series connection of C2 and Cₒᵤₜ. As the circuit is assumed to be in steady state, the voltage for C3 and Cₒᵤₜ must be equal, as was shown earlier, and the voltage for C2 was found in the last step to be equal to 2Vₒᵤₜ, resulting in the voltage across C1 being equal to 3Vₒᵤₜ.

(6) Now the input voltage can be found. The input voltage must be equal to the voltage across the series connection of C1 and C2. From the prior steps, this C1 is equal to 3Vₒᵤₜ and C2 is equal to 2Vₒᵤₜ, resulting in Vᵢₙ needing to be equal to 5Vₒᵤₜ.

(7) When Vᵢₙ is equal to 5V then the output voltage is equal to 1V. This demonstrates that a Fibonacci converter composed of three unit cells has a conversion ratio equal to 5:1, or can be reversed to create a conversion ratio of 1:5.

Higher order Fibonacci converters can be realized by following the pattern from FIG. 2A with each additional unit cell increasing/decreasing conversion ratio to the next value in the Fibonacci sequence.

### 1.3. Up Converting Fibonacci Converters

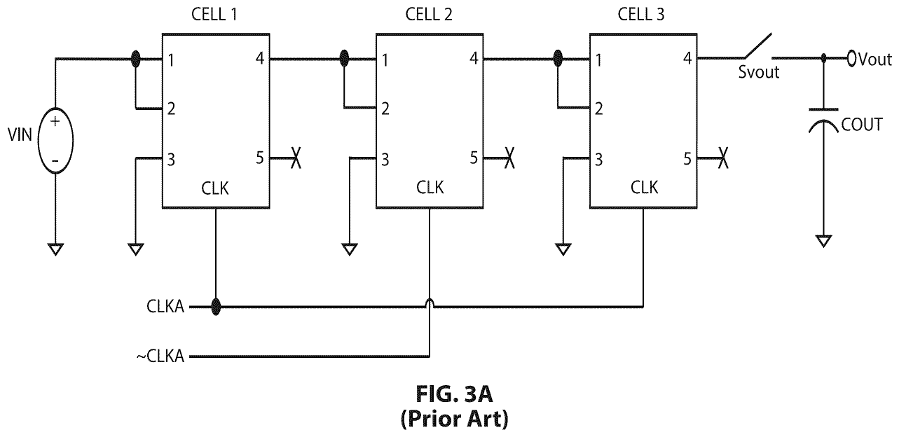

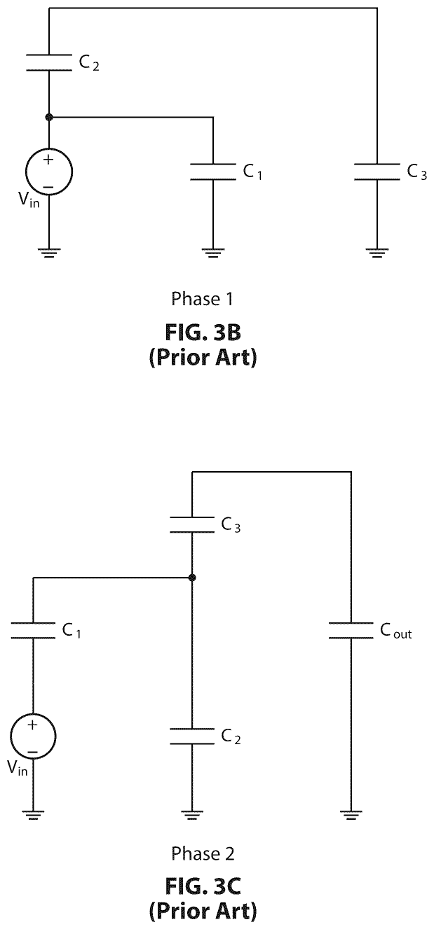

FIG. 3A through FIG. 3C depict an up converting Fibonacci Converter.

In FIG. 3A is an example circuit, similar to FIG. 2A, but depicting a step-up converter which reverses the direction of the unit cells between input voltage V_{IN}, and output voltage Vo_{OUT}. In addition, switch S_{VIN} from FIG. 2A, is now used at the output switch Sᵥₒᵤₜ.

The switches are controlled in two phases. In phase 1, in CELL 1 and CELL 3, switch S2 is open while switches S1 and S3 are closed. Switch S_{VOUT} is open during this phase. In CELL 2 switch S2 is closed and switches S1 and S3 are open. In phase 2 in CELL 1 and CELL 3, switches S1 and S3 are open while switch S2 is closed. In CELL 2 switch S2 is open and switches S1 and S3 are closed. Switch S_{VOUT} is closed during this phase.

Describing FIG. 3A from a connection standpoint, V_{IN} is connected to CELL 1 through the combination of connection 1 and connection 2. In all three cells connection 3 is tied to ground, and connection 5 is open, or may be coupled to connection 3. The clock inputs for CELL 1 and CELL 3 (odd numbered cells) receive clock CLKA, while its inverse ˜CLKA is received for CELL2. Output from each unit cell is through connection 4 into connection 1 and connection 2 in the subsequent cell. Connection 4 from the last cell in the sequence is connected through switch S_{VOUT}, which is clocked out of phase with the last unit cell, and connecting to C_{OUT} with output V_{OUT}.

FIG. 3B and FIG. 3C depict equivalent capacitance diagrams of these two phases. The clock inputs to FIG. 3A are seen to control three switches in each unit cell. The first unit cell receives input voltage V_{IN}, with each subsequent unit cell receiving an input voltage from the previous cell, and the last cell in the series generating an output through switch S_{VOUT} to capacitor C_{OUT} with output voltage V_{OUT}.

In phase 1 each unit cell receives its input voltage which is connected by the switches to put the input voltage in parallel combination with both capacitor C1, and the series combination of capacitor C2 and capacitor C3.

In phase 2 each unit cell receives its input voltage which is connected by the switches to put the input voltage in parallel with the series combination of capacitor C1 and capacitor C2, and coupling the series combination of capacitor C3 and capacitor Cₒᵤₜ in parallel with capacitor C2.

1.4. General Rules for Connecting Fibonacci Cells into a Converter

Switched Capacitor (SC) Fibonacci unit cells are connected for use in step-up or step-down converters following the following six rules:

Connection 1: Couple to single connection 4 of any cell or V_{IN}.

Connection 2: Couple to single connection 4 of any cell or V_{IN}.

Connection 3: Couple to single connection 5 of any cell or reference voltage (ground/0V).

Connection 4: Couple to either one or more of connection 1 or connection 2 of any cell(s) or leave unconnected.

Connection 5: Couple to either one or more of connection 3 of any cell(s) or leave unconnected.

Clock: Logic high or low signal.

It should be noted that FIG. 2A and FIG. 3A, two clock signals are given, CLKA and ˜CLKA. CLKA represents a standard clock signal, with ˜CLKA representing a clock that is out of phase (inverted) from CLKA, when CLKA is high ˜CLKA will be low and when CLKA is low, ˜CLKA will be high.

S_{VIN} is an electronically controlled switch coupled to a CLK signal not connected to CELL 1. S_{VIN} is used to periodically inject charge into the system.

Switch S_{VOUT} is electronically controlled and coupled to a CLK signal not connected to the last cell (e.g., CELL 3 in these examples). S_{VOUT} is used to periodically pull charge from the system.

In both configurations, step-up and step-down, C_{OUT} is a capacitor used to filter output voltage from the last cell (e.g., CELL 3).

Additional SC unit cells can be added beyond the three SC unit cells depicted in the figures. For adding cells in a step-up configuration, a new SC unit cell will be added before and after connection 4 and connection 5 of the current last CELL. For a step-down configuration, a new SC unit cell will be added after connection 1, connection 2, and connection 3 of the cell and before C_{OUT}.

### 1.5. Embodiments of Fibonacci Converters of the Present Disclosure

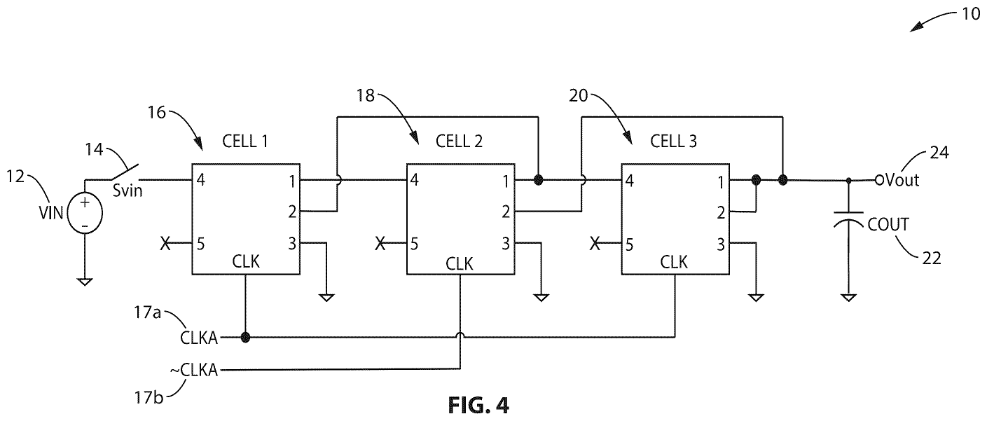

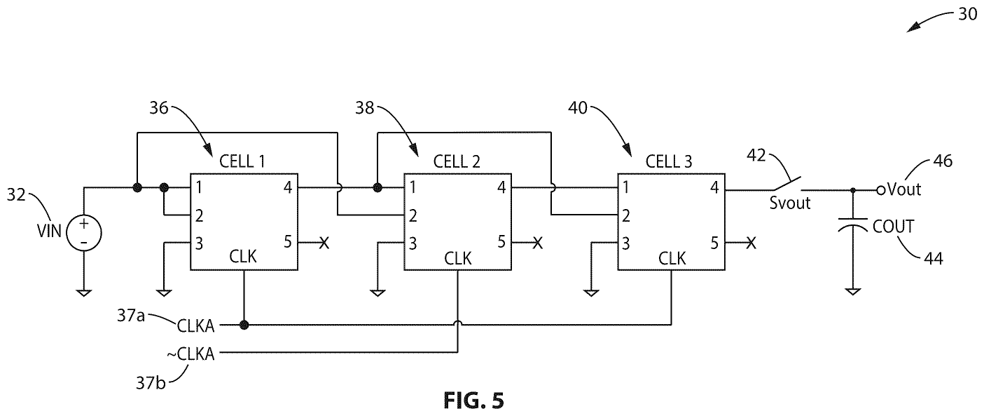

FIG. 4 and FIG. 5 illustrate example embodiments 10, 30 of switched-capacitor (SC) Fibonacci converters having multiple unit cells which can be configured as either step-down or step-up converters.

In comparison to conventional Fibonacci SC converters, such as depicted in FIG. 2A and FIG. 3A, the technology of the present disclosure takes a different approach, although it can make use of the same unit cells shown in FIG. 1.

In FIG. 4 is an example of a step-down configuration 10 of the present disclosure, in which one of the two outputs from a unit cell is connected to the output of the next unit cell, instead of to the input of the next unit cell. Each subsequent intermediate stage (unit cell) is then similarly configured to connect one of the outputs forward to the next stage. Since there is no subsequent stage (unit cell), in the last unit cell of the converter, its two outputs are both connected to the output capacitor.

In this example, the multiple unit cells comprise three unit cells, CELL 1 16, CELL 2 18, and CELL 3 20, although the Fibonacci converter can be extended to any desired number of stages.

More specifically, the figure depicts a voltage source V_{IN} 12 coupled through switch S_{VIN} 14 to a series of connected unit cells 16, 18 and 20, the output from the last unit cell connecting to C_{OUT} 22 to provide voltage V_{OUT} 24. The clock supplied to the even and odd stages are in opposite phases (inverted), with switch S_{VIN} controlled by an odd stage clock. In particular, a clock CLKA 17a and its inverse ˜CLKA 17b are shown connecting to the unit cells to control the switching state of the three switches within each cell.

Although only three unit cells are shown, the embodiment may be expanded to any desired number of unit cells, thus reaching a desired extent along a Fibonacci sequence.

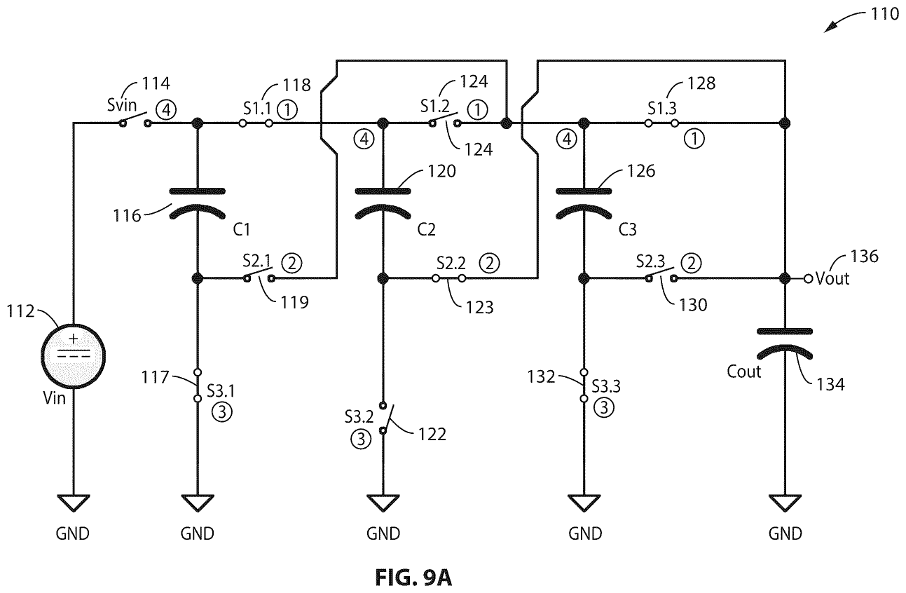

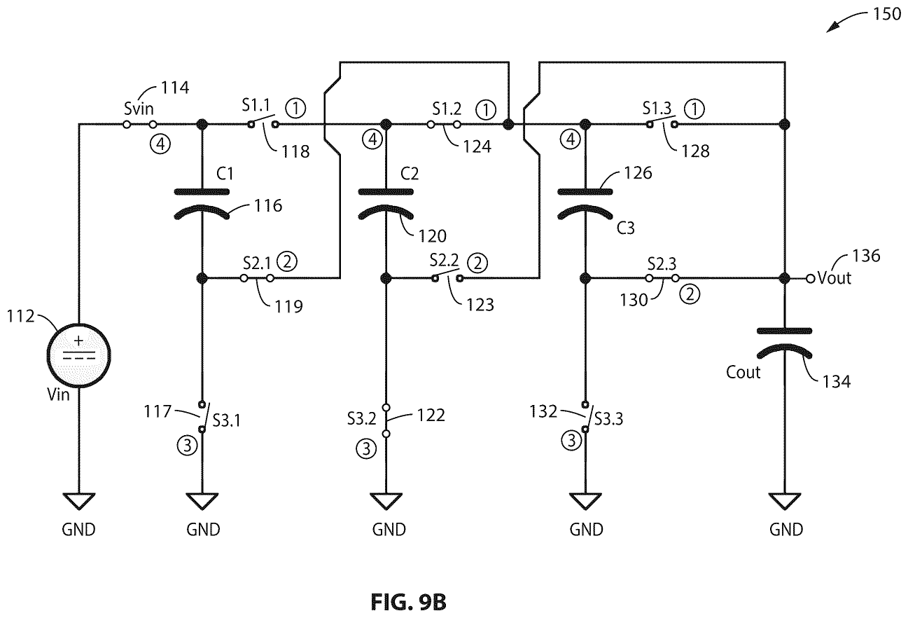

Looking to FIG. 4, and shown in phases states in FIG. 9A and FIG. 9B, it is seen that voltage source V_{IN} 12 is coupled through switch S_{VIN} 14 to unit cell 16 (CELL 1) coupled (through connector 4) to the positive side of the flying capacitor C1 of CELL 1. This same positive side of C1 is then coupled through switch S1 of the unit cell (through connection 1) and coupled to a positive side (through connector 4) to the flying capacitor C2 of CELL 2. In CELL 1, the opposite side (negative side) of flying capacitor C1 is coupled (through connection 2) to an output side of CELL 2, specifically to connection 1, in this subsequent unit cell. In all three cells, connection 3 is coupled to ground, and connection 5 is left open, or coupled to connection 3.

Outputs from CELL 2 are then shown having the positive side of flying capacitor C2 coupled through switch S1 and then (through connector 1) to the positive side of the flying capacitor C3 of CELL 3. In CELL 3, both sides of flying capacitor C3 are coupled to switches S1 and S2, respectively, and connected together coupled to C_{OUT} 22 to provide voltage V_{OUT} 24. Thus, it is seen that the last unit cell simply gangs the switched connections to the flying capacitor together as an output, while it additionally receives the output from the previous unit cell stage.

In FIG. 5 is an example of a step-up converter configuration 30 of the present disclosure, in which one of the two switched inputs to the flying capacitor are coupled to one of one of those inputs in a previous unit cell stage. By way of example and not limitation, the figure is shown with three unit cells, although the converter can be scaled to include any desired number of stages. CELL 1 will always couple connection 1 and connection 2 to V_{IN} for a step-up configuration.

Looking to FIG. 5, it is seen that voltage source V_{IN} 32 is coupled to CELL 1 36, CELL 2 38 and CELL 3 40, which outputs through switch S_{VOUT} 42 to capacitor C_{OUT} 44 with voltage V_{OUT} 46. The clock supplied to the even and odd stages are in opposite phases (inverted), with switch S_{VOUT} controlled by an odd stage clock. In particular, a clock CLKA 37a and its inverse ˜CLKA 37b are shown connecting to the unit cells to control the switching state of the three switches within each cell.

More particularly, voltage source V_{IN} 32 is coupled to CELL 1 36 (through connections 1 and 2) which are coupled through switches S1 and S2 of the first unit cell 36 to either side of its flying capacitor C1. In addition, connection 2 of CELL 2 38 (which is coupled through switch S2 in CELL 2 to its flying capacitor C2) is also connected to the voltage input to CELL 1. In all three cells, connection 3 is coupled to ground, and connection 5 is left open, or connected to connection 3.

A similar connection is made between the subsequent stages. In this case, connection 4 from CELL 1 is coupled to connection 1 of CELL 2. In addition, connection 2 from CELL 3 is coupled back to connection 1 of CELL 2.

In the final stage of CELL 3, an input is received from connection 4 of CELL 2, to connection 1 (which is coupled through switch S1 to the positive side of flying capacitor C3). Since this is the last stage, there are no additional connections from subsequent stages coupled to connection 1 of CELL 3. Output from CELL 3 is through connector 4 (connecting to the positive side of the flying capacitor C3) and passing through switch S_{VOUT} 42 to capacitor C_{OUT} 44 at voltage V_{OUT} 46.

### 1.6. Benefits of the Disclosed SC Fibonacci Converters

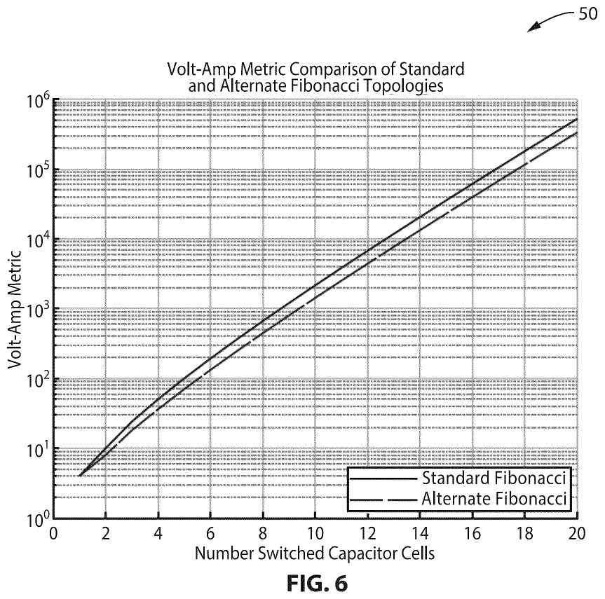

FIG. 6 illustrates an example embodiment 50 of results comparing a volt-amp metric as a function of the number of switched capacitor cells. The upper graph depicting that of the standard Fibonacci converters, such as seen in FIG. 2A and FIG. 3A, with that of the disclosed Fibonacci converters of FIG. 4 and FIG. 5.

The present disclosure provides a number of benefits when compared to conventional Fibonacci converters; for example, providing the same conversion ratio for the same exact number of switched-capacitor unit cells, while significantly increasing efficiency, such as a maximum increase in efficiency of 38% according to the simulations. Thus, the SC topology of the Fibonacci converters of the present disclosure are able to achieve an equal or a lower Volt-Amp metric for any given number of cascaded unit cells.

### 1.7. Embodiments of Unit Cells of the Present Disclosure

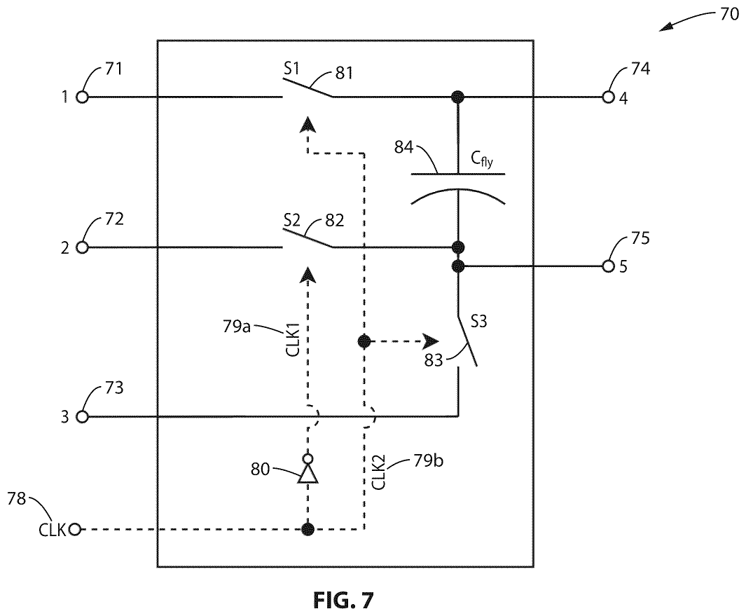

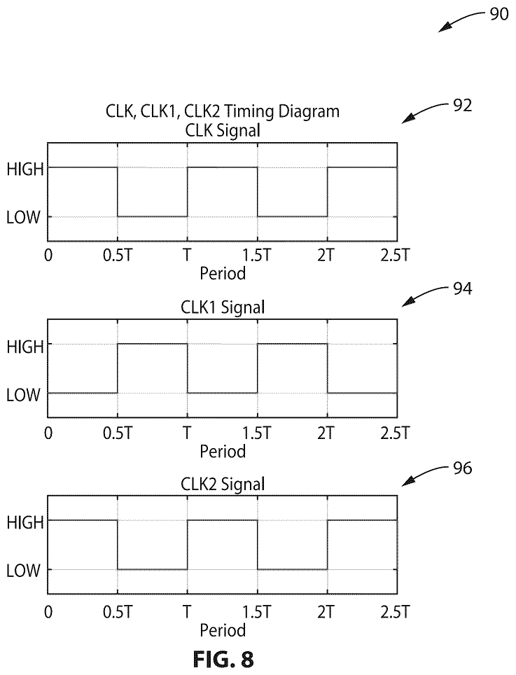

FIG. 7 and FIG. 8 illustrates a switched capacitor converter unit cell which can be utilized with the present disclosure, as well as the clock signals used in the unit cell.

In FIG. 7 is illustrated a unit cell 70 showing its components and connections to other unit cells. Connections 71 through 75 to the unit cell are shown corresponding to connections 1 through 5 seen in FIG. 1 through FIG. 5. A clock signal CLK 78 is shown, which is inverted by inverter 80 resulting in CLK1 signal 79a, while the non-inverted clock is shown as CLK2 79b. When two or more unit cells are connected in series, then the clock signals provided to every other unit cell are inverted.

The unit cell is shown with its flying capacitor 84 and electronically controlled switches S1 81, S2 82, and S3 83, which allow coupling in different ways to capacitor 84 and the adjacent unit cells as well as to the input and output sides of the converter.

Connection 71 (1) is coupled through switch S1 81 that is controlled by control signal CLK 2 79b. When S1 is high, connection 71 (1) couples to the top plate (e.g., positive side) of flying capacitor C_{fly} 84. Connection 74 (4) is a direct connection to the top plate (e.g., positive side) of flying capacitor C_{fly} 84. When CLK2 is low, S1 is disconnected, and thus connection 71 (1) to the capacitor 84 is disconnected, and there is no path from connection 71 (1) to connection 74 (4).

Connection 72 (2) is coupled through switch S2 82 to the bottom plate (e.g., negative side) of flying capacitor C_{fly} 84. Connection 75 (5) is a direct connection to the bottom plate (e.g., negative side) of flying capacitor C_{fly} 84. When CLK1 79a is high, then S2 is on, and thus connection 72 (2) is connected to the bottom plate (e.g., negative side) of flying capacitor C_{fly} 84, and to connection 75 (5). When CLK1 79a is low, then S2 is turned off and connection 72 (2) is disconnected from both connection 75 (5) and bottom plate (e.g., negative side) of flying capacitor C_{fly} 84.

Connection 73 (3) is coupled through switch S3 83 controlled by CLK2 79b. When CLK2 79b is high, then switch S3 83 is on, and connection 73 (3) is coupled to the bottom plate (e.g., negative side) of flying capacitor C_{fly}84, as well as to connection 75 (5). When CLK2 79b off, S3 is off and connection 73 (3) is disconnected from the bottom plate (e.g., negative side) of flying capacitor C_{fly} 84, and to connection 75 (5).

When one of these switches is in the on state, it operates as a short, and when off it operates as an open circuit; which is how the switches are depicted in FIG. 9A and FIG. 9B.

Connection 71 (1) is an analog voltage connection for the Fibonacci SC cell, and is configured for connecting to connection 74 (4) of another SC unit cell, or to a voltage source V_{IN} when in a down converter, or toward the output when in an up converter.

Connection 72 (2) is the analog voltage connection for the SC unit cell. Connection 72 (2) is configured for coupling to connection 71 (1) of the same, or a different SC unit cell, or to a voltage source V_{IN} when in an up converter, or toward the output when in a down converter.

Connection 73 (3) is the analog voltage connection for the SC unit Cell. Connection 73 (3) is configured for connecting to either a reference DC voltage (e.g., ground), or to SC unit cell connection 75 (5).

Connection 74 (4) is the analog voltage connection for direct connection to the top plate (e.g., positive side) of the flying capacitor in the SC unit Cell. Connection 74 (4) is configured for coupling to an SC unit cell connection 71 (1) or connection 72 (2) or to a voltage source when in a down converter, or to an output when in an up converter. Connection 74 (4) will connect to connection 71 (1) when switch S1 is in its on state.

Connection 75 (5) is the analog voltage connection for direct connection to the bottom plate (e.g., negative side) of the flying capacitor in the SC unit cell. Connection 74 (4) is configured for connection to SC unit cell connection 73 (3) or left unconnected. Connection 75 (5) connect to connection 72 (2) when switch S2 is in its on state, or to connection 73 (3) when switch S3 is in its on state, but in view of the phasing of the clocks it will never connect to both connection 72 (2) and connection 73 (3) simultaneously.

FIG. 8 illustrates an example embodiment 90 of a corresponding timing diagram for CLK 92, CLK1 94 and CLK3 96. CLK is a digital input signal for an SC unit cell and has one of two states, high (e.g., “1” state), or low (e.g., “0” state). CLK drives two internal signals within an SC unit cell, CLK1 and CLK2. CLK is a square wave with an adjustable duty cycle (percentage of time that the signal is on). CLK state is exemplified as compared to the state of CLK1 and CLK2 in FIG. 8 with a period having a 50% duty cycle. CLK1 is out of phase with the CLK signal, such as through an inverter 80 seen in FIG. 7. When CLK is high, CLK1 is low. When CLK is low, CLK1 is high. CLK2 is in phase with the CLK signal. When CLK is high, CLK2 is high. When CLK is low, CLK2 is low.

FIG. 9A and FIG. 9B are schematic diagrams illustrating two phases of operation of a step-down configuration, such as seen in FIG. 4. As discussed above, SC unit cells can be connected to other SC unit cells in two configurations, step-up (V_{OUT} is greater than V_{IN}) or step-down (V_{OUT} is less than V_{IN}). The connection numbers reflected here will reference those used in FIG. 7. The figures also depict connection numbers for the unit cells as shown circled, to aid understanding.

In FIG. 9A is shown phase 1 of operation, with CLK being sent to odd numbered unit cells (cell 1 and 3 in this example), and inverse CLK (˜CLK) being sent to even numbered unit cells (cell 2 in this example). Each unit cell may have its own inverter to alter the incoming CLK or ˜CLK to drive the internal switches of that unit cell in the proper phasing.

In this phase Vᵢₙ 112 is not connected through switch S_{VIN} 114 to the first unit cell. In this first unit cell, the upper plate (e.g., positive side) of flying capacitor C1 116 is coupled through (connection 71 (1) in this first unit cell) to switch S1.1 (S1.1 indicating S1 in the 1^{st} unit cell) 118 through connection 74 (4) of the second unit cell to its flying capacitor C2 120. Switch S2.1 denoted as 119, is open. Switch S3.1 117 is closed, whereby the bottom plate (e.g., negative side) of flying capacitor C1 116 is connected to ground.

The upper plate (e.g., positive side) of flying capacitor C2 120 of the 2^{nd} unit cell is not connected through switch S1.2 124 to a subsequent unit cell. Switch S2.2 123 is closed and thus connects from the bottom plate (e.g., negative side) of flying capacitor C2 120 to C_{OUT} 134. Switch S3.2 122 is open, and thus the bottom plate of the capacitor is not connected to ground.

The upper plate (e.g., positive side) of flying capacitor C3 126 of the 3^{rd} unit cell is connected through switch S1.3 128 to C_{OUT} 134 at voltage V_{OUT} 136. Switch S2.3 130 is open. Switch S3.3 132 is closed and thus the bottom plate (e.g., negative side) of flying capacitor C3 126 is grounded.

In FIG. 9B is shown the alternate phase, phase 2, of converter operation. The same switches are shown, but in different states as described below.

In this second phase, voltage Vin 112 is connected through closed switch S_{VIN} 114 to connection 74 (4) of the first unit cell, and thus directly coupled to the upper plate (e.g., positive side) of flying capacitor C1 116. As switch S1.1 118 is open, the upper plate (e.g., positive side) of flying capacitor C1 116 is not connected to the next unit cell. Switch S2.1 119, is closed, whereby the lower plate (e.g., negative side) of flying capacitor C1 116 is coupled through switch S1.2 124 to the upper plate of flying capacitor C2 120, and coupled through connection 74 (4) to the upper plate of flying capacitor C3 126. Switch S3.1 117 is open and the bottom plate (e.g., negative side) of flying capacitor C1 116 is not grounded.

The upper plate (e.g., positive side) of flying capacitor C2 120 of the 2^{nd} unit cell is connected through switch S1.2 124 to a subsequent unit cell, specifically through connection 74 (4) of the 3rd unit cell to the top plate of flying capacitor C3 126. Switch S2.2 123 is open and thus not connected to a subsequent unit cell stage. Switch S3.2 122 is closed, and thus the bottom plate of flying capacitor 120 is grounded.

The upper plate (e.g., positive side) of flying capacitor C3 126 of the 3^{rd} unit cell is not connected through switch S1.3 128. Switch S2.3 130 is closed whereby the bottom plate of flying capacitor C3 126 is connected to C_{OUT} 134 with Voltage Output V_{OUT} 136. Switch S3.3 132 is open and thus the bottom plate (e.g., negative side) of flying capacitor C3 126 is not grounded.

It should also be appreciated that in at least one embodiment, the distinction of the present disclosure, is the change as to the how connection 2, as the switched connection to the lower plate of the flying capacitor, is coupled. Instead of being coupled with connection 1, the switched connection to the upper plate of the flying capacitor, it is coupled to connection 1 of a preceding, or succeeding, unit cell. This change results in elimination of series losses, which improves switched capacitor converter efficiency since less losses translates to higher efficiency.

1.8. Embodiment with Simplified Down/Up Conversion

This embodiment is a slight alteration of the converters shown in FIG. 4 and FIG. 5, respectively. The principle difference between a step-up and step-down converter is the location where Vᵢₙ and V_{OUT} are located.

The example of FIG. 4, for example, may be changed to a step-up converter by merely swapping the voltage source (V_{IN}) with the capacitor C_{OUT} and output node Vₒᵤₜ. It is not important on which side the switch S_{VIN} or Sᵥₒᵤₜ resides in the converter.

### 2. General Scope of Embodiments

From the description herein, it will be appreciated that the present disclosure encompasses multiple implementations of the technology which include, but are not limited to, the following:

A cascaded Fibonacci switched capacitor (SC) converter, comprising: (a) a plurality of unit cells, each unit cell comprising: (a) (i) a charge storage capacitor connecting to three electronically controlled switches S1, S2 and S3; (a) (ii) an input configured for receiving a clock signal (CLK), which activates switches S1 and S3 when set in a first logic state, and activates switch S2 when set in a second logic state; (a) (iii) wherein a first side of said capacitor is coupled in parallel to a fourth external connection (Conn4), and through a first switch (S1) to a first external connection (Conn1), a second side of said capacitor coupled through a first switch (S1) to a first external connection (Conn1), and through a third switch (S3) to ground; (b) wherein said plurality of said unit cells are cascaded together, having a first unit cell, one or more intermediate unit cells, and a terminating unit cell; wherein each odd numbered unit cell receives the CLK signal, and each even numbered unit cell receives an inverse of the CLK signal; (c) wherein said SC converter comprises: (c) (i) a step down converter comprising: (c) (i) (A) wherein the first unit cell (Cell1) of said cascaded Fibonacci switched capacitor (SC) is configured for receiving a power input through a switch S_{VIN} through Conn4 of the unit cell to a capacitor C1 of this first unit cell; wherein the first side of C1 is output on Conn1 of this unit cell, and wherein a second side of C1 connects through its switch S2 to its Conn2; wherein said switch S_{VIN} is configured for being activated in response to said CLK being in the second logic state; and (c) (i) (B) wherein the one or more intermediate unit cells are configured for being sequentially coupled to one another between Cell 1 and the terminating unit cell; wherein Conn4 of each unit cell connects back to Conn1 from the previous unit cell, and connects back from its own Conn1 back to Conn2 to the prior unit cell; (c) (i) (C) wherein the terminating unit cell is configured with its Conn4 connecting back to Conn1 from the previous unit cell, and connecting back from its own Conn1 back to Conn2 to the prior unit cell, and for having its Conn1 and Conn2 coupled to an output capacitor C_{OUT} at the voltage V_{OUT}; or (c) (ii) a step up converter comprising: (c) (ii) (A) wherein the first unit cell (Cell1) of said cascaded Fibonacci switched capacitor (SC) is configured for receiving a power input through to Conn1 and Conn2 of the unit cell to a capacitor C1 of this first unit cell; wherein the first side of C1 is output on Conn4 of this unit cell, and wherein Conn1 of this first cell also is coupled to Conn2 of the following unit cell; (c) (ii) (B) wherein the one or more intermediate unit cells are configured for being sequentially coupled to one another between Cell 1 and the terminating unit cell; wherein Conn2 of each unit cell connects back to Conn1 of the previous unit cell; (c) (ii) (C) wherein the terminating unit cell is configured with its Conn4 coupled through switch S_{VOUT} to an output capacitor C_{OUT} and for outputting voltage V_{OUT}; wherein switch S_{VOUT} is configured for being activated in response to said CLK being in the second logic state; (d) wherein the alternate phases of the cascaded unit cells switch power to and from both sides of the capacitor of each unit cell of this SC converter to change voltage gain between unit cell stages in accord with the Fibonacci sequence.

A cascaded Fibonacci switched capacitor (SC) down converter, comprising: (a) a plurality of unit cells, each unit cell comprising: (a) (i) a charge storage capacitor connecting to three electronically controlled switches S1, S2 and S3; (a) (ii) an input configured for receiving a clock signal (CLK), which activates switches S1 and S3 when set in a first logic state, and activates switch S2 when set in a second logic state; (a) (iii) wherein a first side of said capacitor is coupled in parallel to a fourth external connection (Conn4), and through a first switch (S1) to a first external connection (Conn1), a second side of said capacitor coupled through a first switch (S1) to a first external connection (Conn1), and through a third switch (S3) to ground; (b) wherein said plurality of said unit cells are cascaded together, having a first unit cell, one or more intermediate unit cells, and a terminating unit cell; wherein each odd numbered unit cell receives the CLK signal, and each even numbered unit cell receives an inverse of the CLK signal; (c) wherein the first unit cell (Cell1) of said cascaded Fibonacci switched capacitor (SC) is configured for receiving a power input through a switch S_{VIN} through Conn4 of the unit cell to a capacitor C1 of this first unit cell; wherein the first side of C1 is output on Conn1 of this unit cell, and wherein a second side of C1 connects through its switch S2 to its Conn2; wherein said switch S_{VIN} is configured for being activated in response to said CLK being in the second logic state; (d) wherein the one or more intermediate unit cells are configured for being sequentially coupled to one another between Cell 1 and the terminating unit cell; wherein Conn4 of each unit cell connects back to Conn1 from the previous unit cell, and connects back from its own Conn1 back to Conn2 to the prior unit cell; (e) wherein the terminating unit cell is configured with its Conn4 connecting back to Conn1 from the previous unit cell, and connecting back from its own Conn1 back to Conn2 to the prior unit cell, and for having its Conn1 and Conn2 coupled to an output capacitor C_{OUT} at the voltage V_{OUT}; (f) wherein the alternate phases of the cascaded unit cells switch power to and from both sides of the capacitor of each unit cell of this SC converter to divide voltage gain between unit cell stages according to a Fibonacci sequence.

A cascaded Fibonacci switched capacitor (SC) down converter, comprising: (a) a plurality of unit cells, each unit cell comprising: (a) (i) a charge storage capacitor connecting to three electronically controlled switches S1, S2 and S3; (a) (ii) an input configured for receiving a clock signal (CLK), which activates switches S1 and S3 when set in a first logic state, and activates switch S2 when set in a second logic state; (a) (iii) wherein a first side of said capacitor is coupled in parallel to a fourth external connection (Conn4), and through a first switch (S1) to a first external connection (Conn1), a second side of said capacitor coupled through a first switch (S1) to a first external connection (Conn1), and through a third switch (S3) to ground; (b) wherein said plurality of said unit cells are cascaded together, having a first unit cell, one or more intermediate unit cells, and a terminating unit cell; wherein each odd numbered unit cell receives the CLK signal, and each even numbered unit cell receives an inverse of the CLK signal; (c) wherein the first unit cell (Cell1) of said cascaded Fibonacci switched capacitor (SC) is configured for receiving a power input through to Conn1 and Conn2 of the unit cell to a capacitor C1 of this first unit cell; wherein the first side of C1 is output on Conn4 of this unit cell, and wherein Conn1 of this first cell also is coupled to Conn2 of the following unit cell; (d) wherein the one or more intermediate unit cells are configured for being sequentially coupled to one another between Cell 1 and the terminating unit cell; wherein Conn2 of each unit cell connects back to Conn1 of the previous unit cell; (e) wherein the terminating unit cell is configured with its Conn4 coupled through switch S_{VOUT} to an output capacitor C_{OUT} and for outputting voltage V_{OUT}; wherein switch S_{VOUT} is configured for being activated in response to said CLK being in the second logic state; (f) wherein the alternate phases of the cascaded unit cells switch power to and from both sides of the capacitor of each unit cell of this SC converter to divide voltage gain between unit cell stages according to a Fibonacci sequence.

A unit cell for use in a step-up or step-down switching converter, the unit cell comprising: a first electronically controlled switch (S1) that is controlled by a first control signal (C1); a second electronically controlled switch (S2) that is controlled by a second control signal (C2); a third electronically controlled switch (S3) that is controlled by a third control signal (C3); a connection 1, a connection 2, a connection 3, a connection 4, and a connection 5, each said connection comprising an analog voltage connection; a polarized capacitor (CAP) having a positive side and a negative side; a clock connection (CLK); wherein when C1 is on, S1 will turn on and connection 1 will connect to connection 4 and the positive side of capacitor CAP; wherein when C1 is off, S1 will disconnect connection 1 from connection 4 and the positive side of CAP, but connection 4 and the positive voltage connection of CAP will remain connected; wherein when C2 is on, S2 will turn on and connection 2 will connect to connection 5 and the negative side of CAP; wherein when C2 is off, S2 will disconnect connection 2 from connection 5 and the negative side of CAP, but connection 5 and the negative side of CAP will remain connected; wherein when C3 is on, S3 will turn on and connection 3 will connect to connection 5 and the negative side of CAP; wherein when C3 is off, S3 will disconnect connection 3 from connection 5 and the negative side of CAP, but connection 5 and the negative side of CAP will remain connected; wherein when C1 is on, S1 acts as a short; wherein when C1 is off, S1 acts as an open; wherein C1 and C3 are in phase; wherein when C1 is on, C3 is on; wherein when C1 is off, C3 is off; wherein when C2 is on, S2 acts as a short; wherein when C2 is off, S2 acts as an open; wherein C2 is out of phase with C1; wherein when C2 is on, C1 is off; wherein when C2 is off, C1 is on; wherein when C3 is on, S3 acts as a short; wherein when C3 is off, S3 acts as an open; wherein C1 and C3 are in phase; wherein when

C1 is on, C3 is on; wherein when C1 is off, C3 is off; wherein CLK is a digital input signal and has one of two states, high or low; wherein CLK is a square wave with an adjustable duty cycle; wherein CLK drives two internal signals CLK1 and CLK2; wherein CLK1 is a digital input signal controlled by CLK; wherein CLK1 is out of phase with the CLK signal; wherein when CLK is high, CLK1 is low; wherein when CLK is low, CLK1 is high; wherein CLK2 is a digital input signal controlled by CLK; wherein CLK2 is in phase with CLK signal; wherein when CLK is high, CLK2 is high; wherein when CLK is low, CLK2 is low; wherein CLK1 drives control signal C2; and wherein CLK2 drives control signals C1 and C3.

A step down converter comprising a plurality of unit cells of implementation 1, said plurality of unit cells comprising a first unit cell, a second unit cell, and a third unit cell in a cascading arrangement wherein the second unit cell immediately follows the first unit cell and wherein the third unit cell immediately follows the second unit cell, and wherein: connection 1 in the first unit cell is connected to connection 4 in the second unit cell; connection 2 in the first unit cell is connected to connection 1 in the second unit cell; connection 3 in the first unit cell is connected to ground; connection 4 in the first unit cell is connected to a switched voltage source S_{VIN}; connection 1 in the second unit cell is connected to connection 4 in the third unit cell. connection 2 in the second unit cell is connected to connection 1 in the third unit cell; connection 3 in the second unit cell is connected to ground; connections 1 and 2 in the third unit cell are connected together and to a voltage output VOUT; and connection 3 in the third unit cell is connected to ground.

A step up converter comprising a plurality of unit cells of implementation 1, said plurality of unit cells comprising a first unit cell, a second unit cell, and a third unit cell in a cascading arrangement wherein the second unit cell immediately follows the first unit cell and wherein the third unit cell immediately follows the second unit cell, and wherein: connection 1 in the first unit cell is connected to a voltage source V_{IN}, to connection 2 in the first unit cell, and to connection 2 in the second unit cell; connection 3 in the first unit cell is connected to ground; connection 4 in the first unit cell is connected to connection 1 in the second unit cell; connection 1 in the second unit cell is connected to connection 2 in the third unit cell; connection 3 in the second unit cell is connected to ground; connection 4 in the second unit cell is connected to connection 1 in the third unit cell; connection 3 in the third unit cell is connected to ground; and connection 4 in the third unit cell is connected to a switched voltage output SVOUT.

An improved step down converter, comprising: a three-cell Fibonacci switched step down converter having a first cell (CELL 1), a second cell (CELL 2) following the first cell, and a third cell (CELL 3) following the second cell, modified wherein instead of a connection 2 in CELL 1 connecting to a connection 4 in the immediately following CELL 2, connection 2 in CELL 1 skips the immediately following CELL 2 and connects to a connection 4 of CELL 3.

An improved step up converter, comprising: a three-cell Fibonacci switched step up converter having a first cell (CELL 1), a second cell (CELL 2) following the first cell, and a third cell (CELL 3) following the second cell, modified wherein instead of a connection 4 in CELL 1 connecting to a connection 2 in the immediately following CELL 2, connection 4 in CELL 1 skips the immediately following CELL 2 and connects to a connection 2 of CELL 3.

The apparatus of any preceding implementation, wherein each said switch comprises an electronically controlled switch.

The apparatus of any preceding implementation, wherein each said switch electronically controlled switch comprises a transistor.

The apparatus of any preceding implementation, wherein the switches in each unit cell of the SC converter are switched between its first and second phases to provide an equivalent capacitance model which continues the Fibonacci pattern of each unit cell having a gain which is determined in response to preceding stages.

The apparatus of any preceding implementation, wherein capacitor C_{OUT} is a capacitor configured for filtering output voltage from the last cell.

The apparatus of any preceding implementation, wherein said switched-capacitor converter exhibits reduced losses, increased efficiency, and less switch stress compared to a conventional Fibonacci converter.

The apparatus of any preceding implementation, wherein connection 2 in CELL 2 connects to a voltage output (VOUT).

The apparatus of any preceding implementation, wherein connection 2 in CELL 2 connects to a voltage input (VIN).

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A cascaded Fibonacci switched capacitor (SC) converter, comprising:
(a) a plurality of unit cells, each unit cell comprising:
(i) a charge storage capacitor connecting to three electronically controlled switches S1, S2 and S3;
(ii) an input configured for receiving a clock signal (CLK), which activates switches S1 and S3 when set in a first logic state, and activates switch S2 when set in a second logic state;
(iii) wherein a first side of said capacitor is coupled in parallel to a fourth external connection (Conn4), and through a first switch (S1) to a first external connection (Conn1), a second side of said capacitor coupled through a first switch (S1) to a first external connection (Conn1), and through a third switch (S3) to ground;
(b) wherein said plurality of said unit cells are cascaded together, having a first unit cell, one or more intermediate unit cells, and a terminating unit cell; wherein each odd numbered unit cell receives the CLK signal, and each even numbered unit cell receives an inverse of the CLK signal;
(c) wherein said SC converter comprises:
(i) a step down converter comprising:
(A) wherein the first unit cell (Cell1) of said cascaded Fibonacci switched capacitor (SC) is configured for receiving a power input through a switch S_{VIN} through Conn4 of the unit cell to a capacitor C1 of this first unit cell; wherein the first side of C1 is output on Conn1 of this unit cell, and wherein a second side of C1 connects through its switch S2 to its Conn2; wherein said switch S_{VIN} is configured for being activated in response to said CLK being in the second logic state; and
(B) wherein the one or more intermediate unit cells are configured for being sequentially coupled to one another between Cell 1 and the terminating unit cell; wherein Conn4 of each unit cell connects back to Conn1 from the previous unit cell, and connects back from its own Conn1 back to Conn2 to the prior unit cell;
(C) wherein the terminating unit cell is configured with its Conn4 connecting back to Conn1 from the previous unit cell, and connecting back from its own Conn1 back to Conn2 to the prior unit cell, and for having its Conn1 and Conn2 coupled to an output capacitor C_{OUT} at the voltage V_{OUT}; or
(ii) a step up converter comprising:
(A) wherein the first unit cell (Cell1) of said cascaded Fibonacci switched capacitor (SC) is configured for receiving a power input through to Conn1 and Conn2 of the unit cell to a capacitor C1 of this first unit cell; wherein the first side of C1 is output on Conn4 of this unit cell, and wherein Conn1 of this first cell also is coupled to Conn2 of the following unit cell;
(B) wherein the one or more intermediate unit cells are configured for being sequentially coupled to one another between Cell 1 and the terminating unit cell; wherein Conn2 of each unit cell connects back to Conn1 of the previous unit cell;
(C) wherein the terminating unit cell is configured with its Conn4 coupled through switch S_{VOUT} to an output capacitor C_{OUT} and for outputting voltage V_{OUT}; wherein switch S_{VOUT} is configured for being activated in response to said CLK being in the second logic state;
(d) wherein the alternate phases of the cascaded unit cells switch power to and from both sides of the capacitor of each unit cell of this SC converter to change voltage gain between unit cell stages in accord with the Fibonacci sequence.

2. The apparatus of claim 1, wherein each said switch comprises an electronically controlled switch.

3. The apparatus of claim 2, wherein each said switch electronically controlled switch comprises a transistor.

4. The apparatus of claim 1, wherein the switches in each unit cell of the SC converter are switched between its first and second phases to provide an equivalent capacitance model which continues the Fibonacci pattern of each unit cell having a gain which is determined in response to preceding stages.

5. The apparatus of claim 1, wherein capacitor C_{OUT} is a capacitor configured for filtering output voltage from the last cell.

6. The apparatus of claim 1, a switched-capacitor converter that exhibits reduced losses, increased efficiency, and less switch stress compared to a conventional Fibonacci converter.

7. A cascaded Fibonacci switched capacitor (SC) down converter, comprising:
(a) a plurality of unit cells, each unit cell comprising:
(i) a charge storage capacitor connecting to three electronically controlled switches S1, S2 and S3;
(ii) an input configured for receiving a clock signal (CLK), which activates switches S1 and S3 when set in a first logic state, and activates switch S2 when set in a second logic state;
(iii) wherein a first side of said capacitor is coupled in parallel to a fourth external connection (Conn4), and through a first switch (S1) to a first external connection (Conn1), a second side of said capacitor coupled through a first switch (S1) to a first external connection (Conn1), and through a third switch (S3) to ground;
(b) wherein said plurality of said unit cells are cascaded together, having a first unit cell, one or more intermediate unit cells, and a terminating unit cell; wherein each odd numbered unit cell receives the CLK signal, and each even numbered unit cell receives an inverse of the CLK signal;
(c) wherein the first unit cell (Cell1) of said cascaded Fibonacci switched capacitor (SC) is configured for receiving a power input through a switch S_{VIN} through Conn4 of the unit cell to a capacitor C1 of this first unit cell; wherein the first side of C1 is output on Conn1 of this unit cell, and wherein a second side of C1 connects through its switch S2 to its Conn2; wherein said switch S_{VIN} is configured for being activated in response to said CLK being in the second logic state;
(d) wherein the one or more intermediate unit cells are configured for being sequentially coupled to one another between Cell 1 and the terminating unit cell; wherein Conn4 of each unit cell connects back to Conn1 from the previous unit cell, and connects back from its own Conn1 back to Conn2 to the prior unit cell;
(e) wherein the terminating unit cell is configured with its Conn4 connecting back to Conn1 from the previous unit cell, and connecting back from its own Conn1 back to Conn2 to the prior unit cell, and for having its Conn1 and Conn2 coupled to an output capacitor C_{OUT} at the voltage V_{OUT};
(f) wherein the alternate phases of the cascaded unit cells switch power to and from both sides of the capacitor of each unit cell of this SC converter to divide voltage gain between unit cell stages according to a Fibonacci sequence.

8. The apparatus of claim 7, wherein each said switch comprises an electronically controlled switch.

9. The apparatus of claim 8, wherein each said switch electronically controlled switch comprises a transistor.

10. The apparatus of claim 7, wherein the switches in each unit cell of the SC converter are switched between its first and second phases to provide an equivalent capacitance model which continues the Fibonacci pattern of each unit cell having a gain which is determined in response to preceding stages.

11. The apparatus of claim 7, wherein capacitor C_{OUT} is a capacitor configured for filtering output voltage from the last cell.

12. The apparatus of claim 7, a switched-capacitor converter that exhibits reduced losses, increased efficiency, and less switch stress compared to a conventional Fibonacci converter.

13. A cascaded Fibonacci switched capacitor (SC) down converter, comprising:
(a) a plurality of unit cells, each unit cell comprising:
(i) a charge storage capacitor connecting to three electronically controlled switches S1, S2 and S3;
(ii) an input configured for receiving a clock signal (CLK), which activates switches S1 and S3 when set in a first logic state, and activates switch S2 when set in a second logic state;
(iii) wherein a first side of said capacitor is coupled in parallel to a fourth external connection (Conn4), and through a first switch (S1) to a first external connection (Conn1), a second side of said capacitor coupled through a first switch (S1) to a first external connection (Conn1), and through a third switch (S3) to ground;
(b) wherein said plurality of said unit cells are cascaded together, having a first unit cell, one or more intermediate unit cells, and a terminating unit cell; wherein each odd numbered unit cell receives the CLK signal, and each even numbered unit cell receives an inverse of the CLK signal;
(c) wherein the first unit cell (Cell1) of said cascaded Fibonacci switched capacitor (SC) is configured for receiving a power input through to Conn1 and Conn2 of the unit cell to a capacitor C1 of this first unit cell; wherein the first side of C1 is output on Conn4 of this unit cell, and wherein Conn1 of this first cell also is coupled to Conn2 of the following unit cell;
(d) wherein the one or more intermediate unit cells are configured for being sequentially coupled to one another between Cell 1 and the terminating unit cell; wherein Conn2 of each unit cell connects back to Conn1 of the previous unit cell;
(e) wherein the terminating unit cell is configured with its Conn4 coupled through switch S_{VOUT} to an output capacitor C_{OUT} and for outputting voltage V_{OUT}; wherein switch S_{VOUT} is configured for being activated in response to said CLK being in the second logic state;
(f) wherein the alternate phases of the cascaded unit cells switch power to and from both sides of the capacitor of each unit cell of this SC converter to divide voltage gain between unit cell stages according to a Fibonacci sequence.

14. The apparatus of claim 13, wherein each said switch comprises an electronically controlled switch.

15. The apparatus of claim 14, wherein each said switch electronically controlled switch comprises a transistor.

16. The apparatus of claim 13, wherein the switches in each unit cell of the SC converter are switched between its first and second phases to provide an equivalent capacitance model which continues the Fibonacci pattern of each unit cell having a gain which is determined in response to preceding stages.

17. The apparatus of claim 13, wherein capacitor C_{OUT} is a capacitor configured for filtering output voltage from the last cell.

18. The apparatus of claim 13, a switched-capacitor converter that exhibits reduced losses, increased efficiency, and less switch stress compared to a conventional Fibonacci converter.

19. A cascaded Fibonacci switched capacitor (SC) converter, comprising:
(a) a plurality of unit cells, each unit cell comprising:
(i) a charge storage capacitor connecting to three electronically controlled switches S1, S2 and S3;
(ii) an input configured for receiving a clock signal (CLK), which activates switches S1 and S3 when set in a first logic state, and activates switch S2 when set in a second logic state;
(iii) wherein a first side of said capacitor is coupled in parallel to a fourth external connection (Conn4), and through a first switch (S1) to a first external connection (Conn1), a second side of said capacitor coupled through a first switch (S1) to a first external connection (Conn1), and through a third switch (S3) to ground;
(b) wherein said plurality of said unit cells are cascaded together, having a first unit cell, one or more intermediate unit cells, and a terminating unit cell; wherein each odd numbered unit cell receives the CLK signal, and each even numbered unit cell receives an inverse of the CLK signal;
(c) wherein converter is configured for either down conversion or up conversion based on the direction the configuration of where the input voltage is applied and the connection of an output capacitor on the opposing side of the converter;
(i) wherein said plurality of said unit cells are cascaded together, for a step down converter comprising:
(A) wherein the first unit cell (Cell1) of said cascaded Fibonacci switched capacitor (SC) is configured for receiving a power input through Conn4 of the unit cell to a capacitor C1 of this first unit cell; wherein the first side of C1 is output on Conn1 of this unit cell, and wherein a second side of C1 connects through its switch S2 to its Conn2; wherein said switch S_{VIN} is configured for being activated in response to said CLK being in the second logic state;
(B) wherein the one or more intermediate unit cells are configured for being sequentially coupled to one another between Cell 1 and the terminating unit cell; wherein Conn4 of each unit cell connects back to Conn1 from the previous unit cell, and connects back from its own Conn1 back to Conn2 to the prior unit cell;
(C) wherein the terminating unit cell is configured with its Conn4 connecting back to Conn1 from the previous unit cell, and connecting back from its own Conn1 back to Conn2 to the prior unit cell, and for having its Conn1 and Conn2 coupled to an output capacitor C_{OUT} at the voltage V_{OUT}; or
(ii) wherein said plurality of said unit cells are cascaded together, for a step up converter by swapping the connection of Vin and that of Cout on the two ends of the step down converter, to arrive at a step up converter;
(d) wherein a switch is inserted in series with the input or output side of the converter and switched by the opposing phase of the clock associated with its nearest unit cell; and
(e) wherein the alternate phases of the cascaded unit cells switch power to and from both sides of the capacitor of each unit cell of this SC converter to divide voltage gain between unit cell stages according to a Fibonacci sequence.
